(19) United States
(12) Patent Application Publication
(10) Pub. No.: US 2026/0058085 A1
(43) Pub. Date: Feb. 26, 2026

(54) DETECTOR WITH MOVEMENT MECHANISM FOR LAMP SEAT

(71) Applicant: Agilent Technologies, Inc., Santa Clara, CA (US)

(72) Inventors: Christian Hirn, Waldbronn (DE); Christoph Keppler, Karlsruhe (DE); Tobias Kheim, Waldbronn (DE)

(21) Appl. No.: 19/251,392

(22) Filed: Jun. 26, 2025

(30) Foreign Application Priority Data
Jun. 28, 2024 (GB) 2409393.2

(51) Int. Cl. H01J 5/60; G01N 30/74

(52) U.S. Cl. CPC H01J 5/60; G01N 30/74

(57) ABSTRACT

A detector for an analytical device for analyzing a fluidic sample includes a housing, a lamp seat arranged in the housing and configured to receive a lamp for generating an electromagnetic radiation, and a movement mechanism to swivel the lamp seat with respect to the housing, and/or move the lamp seat between an operating orientation and a service orientation, so that the movement from the service orientation to the operating orientation results automatically in an electric contact and/or a mechanical positioning, in particular alignment, of the lamp.

### CROSS-REFERENCE TO RELATED APPLICATIONS

This application claims the benefit of the filing date of British Patent Application No. GB 2409393.2, filed on Jun. 28, 2024, the disclosure of which is hereby incorporated herein by reference.

### TECHNICAL FIELD

The present disclosure relates to a detector for an analytical device (for analyzing a fluidic sample). The detector includes a housing, a lamp seat, and a movement mechanism. The lamp seat is arranged in the housing and is configured to receive a lamp for generating an electromagnetic radiation. The movement mechanism is configured to swivel the lamp seat with respect to the housing and/or move the lamp seat between an operating orientation and a service orientation, so that the movement from the service orientation to the operating orientation results automatically in an electric contact and/or a mechanical positioning, in particular alignment, of the lamp. Further, the present disclosure refers to an analytical device, in particular a chromatography device such as a high-performance liquid chromatography (HPLC) device, which comprises the detector, and to a method.

### BACKGROUND

Analytical devices are provided for analyzing a sample, such as for carrying out a chromatographic separation of the sample.

For example, for liquid separation in a chromatography system, a mobile phase comprising a sample fluid (e.g. a chemical or biological mixture) with compounds to be separated is driven through a stationary phase (such as a chromatographic column packing), thus separating different compounds of the sample fluid which may then be identified.

The mobile phase, typically comprised of one or more solvents, is pumped under high-pressure typically through a chromatographic column containing packing medium (also referred to as packing material or stationary phase). As the sample is carried through the column by the liquid flow, the different compounds, each one having a different affinity to the packing medium, move through the column at different speeds. Those compounds having greater affinity for the stationary phase move more slowly through the column than those having less affinity, and this speed differential results in the compounds being separated from one another as they pass through the column. The stationary phase is subject to a mechanical force generated in particular by a hydraulic pump that pumps the mobile phase usually from an upstream connection of the column to a downstream connection of the column. As a result of flow, depending on the physical properties of the stationary phase and the mobile phase, a relatively high-pressure drop is generated across the column.

The mobile phase with the separated compounds exits the column and passes through a flow cell of a detector. The separated fluidic sample flows through the flow cell and is illuminated by light from a light source while being optically detected by the detector. The detector registers and/or identifies the molecules, for example by spectrophotometric absorbance measurements or fluorescence measurements. A two-dimensional plot of the detector measurements against elution time or volume, known as a chromatogram, may be made, and from the chromatogram the compounds may be identified and quantified. For each compound, the chromatogram displays a separate curve feature also designated as a “peak”.

Such an optical detector comprises in a housing a lamp to illuminate the fluidic sample in the flow cell. However, handling, especially exchanging, the lamp of the detector may be difficult, cumbersome and even dangerous for a user. An analytical device such as an HPLC might be configured as a stack of modules, with one of them being the detector module. In case the lamp of the detector has to be changed (this may be necessary after some weeks or months), the detector module has to be dismounted from the stack and the housing has to be disassembled, including removing a plurality of screws. Further, the lamp is normally supplied by high voltage, so that the actual change of the lamp may be difficult and dangerous for the operator.

### SUMMARY

There may be a need to change the lamp of a detector of an analytical device in an efficient and secure manner.

According to a first aspect of the disclosure, there is described a detector (e.g. with a flow cell) for an analytical device (e.g. an HPLC), in particular for analyzing a fluidic sample, wherein the detector comprises: i) a housing, ii) a lamp seat, arranged in the housing, and configured to receive a lamp (e.g. a high-voltage lamp, in particular as a gas discharge lamp) for generating an electromagnetic radiation (in particular with respect to the fluidic sample), and a movement mechanism to swivel the lamp seat with respect to the housing (e.g. around a vertical axis or around a horizontal axis).

According to a second aspect of the disclosure, there is described a detector (e.g. with a flow cell) for an analytical device (e.g. an HPLC), in particular for analyzing a fluidic sample, wherein the detector comprises: i) a housing, ii) a lamp seat, arranged in the housing, and configured to receive a lamp (e.g. a high-voltage lamp, in particular a gas discharge lamp) for generating an electromagnetic radiation (in particular with respect to the fluidic sample), and a movement mechanism to move the lamp seat between an operating orientation and a service orientation, so that the movement from the service orientation to the operating orientation results automatically in an electric contact and/or a mechanical positioning (in particular alignment, more in particular with respect to an optical path) of the lamp.

According to a third aspect of the disclosure, there is described an analytical device for analyzing a fluidic sample, wherein the analytical device comprises the detector described above.

According to a fourth aspect of the disclosure, there is described a method for changing a lamp of a detector of an analytical device (in particular tool-free and/or adjustment-free), the method comprising:
i) moving a lamp seat with respect to a housing of the detector between an operating orientation (in particular oriented in a vertical direction) and a service orientation (in particular oriented in a horizontal direction).
ii) inserting the lamp in the lamp seat and/or removing the lamp from the lamp seat in the service orientation.
iii) electrically connecting the lamp in the operating orientation.

Hereby, moving comprises a swiveling and/or moving between the service orientation and the operating orientation results automatically in an electric contact and/or a mechanical positioning of the lamp.

In the context of the present document, the term “lamp seat” (which may also be denoted as lamp-housing body) may particularly denote a base portion or base member of a detector having an accommodation volume (such as a recess) for accommodating at least part of a lamp. One electric terminal of the lamp may be electrically connected with a counter terminal of the lamp seat when accommodated in the lamp seat.

In the context of the present document, the term “lamp” may particularly denote a member configured for generating light when supplied with electric power. The mentioned light may have any appropriate wavelength or wavelength range, for instance may comprise visible light, ultraviolet light and/or infrared light.

In the context of the present document, the term “detector” may particularly denote a member of an analytical device, such as a sample separation apparatus, which detects a separated fluidic sample, in particular separated fractions of the fluidic sample. In particular, the detector may comprise a flow cell through which the separated fluidic sample flows and which is illuminated by light generated by the lamp. Such a detector may be an optical detector, for instance a fluorescence detector or an absorbance detector. Light created by such a lamp may be guided to the separated fluidic sample flowing in a flow cell. After interaction between the primary light and the separated fluidic sample, secondary light may propagate from the fluidic sample in the flow cell to a detecting unit, such as a photocell, a linear array of photocells or a two-dimensional array of photocells.

In the context of the present document, the term “analytical device” may in particular refer to a device suitable to perform an analysis of a sample. In an example, the analytical device is applied to analyze (characterize) a sample-by-sample separation (such as chromatography). In the context of the present document, the term “chromatography device” may in particular refer to an instrument suitable to perform a chromatographic analysis, such as for analyzing a sample, such as for carrying out a chromatographic separation of the sample. Examples of an analytical device may include a liquid chromatography (LC) instrument, in particular a high-performance liquid chromatography (HPLC) instrument or an ultra-high performance liquid chromatography (UHPLC) instrument, an electrophoresis system, a microfluidic device, a cell sorter (e.g., FACS-Fluorescence Activated Cell Sorting), or a spectrophotometer. In an embodiment, the analytical device comprising an (optical) detection device coupled to or couplable to a source of pressure.

In the context of this document, the term “fluidic sample” may particularly denote any liquid and/or gaseous medium, optionally including also solid particles, which is to be analyzed. Such a fluidic sample may comprise a plurality of fractions of molecules or particles which shall be separated, for instance small mass molecules or large mass biomolecules such as proteins. Separation of a fluidic sample into fractions may involve a certain separation criterion (such as mass, volume, chemical properties, etc.) according to which a separation is carried out.

In the context of this document, the term “mobile phase” may particularly denote any liquid and/or gaseous medium which may serve as fluidic carrier of the fluidic sample during separation. A mobile phase may be a solvent or a solvent composition (for instance composed of water and an organic solvent such as ethanol or acetonitrile). In an isocratic separation mode of a liquid chromatography apparatus, the mobile phase may have a constant composition over time. In a gradient mode, however, the composition of the mobile phase may be changed over time, in particular to desorb fractions of the fluidic sample which have previously been adsorbed to a stationary phase of a separation unit.

In the context of the present document, the term “fluid/solvent drive” (or pump device) may particularly denote an entity capable of driving a fluid (i.e. a liquid and/or a gas, optionally comprising solid particles), in particular the fluidic sample and/or the mobile phase. For instance, the fluid drive may be a pump (for instance embodied as piston pump or peristaltic pump) or another source of high pressure. For instance, the fluid drive may be a high-pressure pump, for example capable of driving a fluid with a pressure of at least 500 bar. Additionally or alternatively, a motion of the mobile phase can also be triggered by an electrostatic force. In a further embodiment, a metering device may be used as a pressurizing/pump device.

In the context of the present document, the term “sample separation unit” may particularly denote a fluidic member through which a fluidic sample is transferred and which is configured so that, upon conducting the fluidic sample through the separation unit, the fluidic sample will be separated into different groups of molecules or particles. An example for a separation unit is a liquid chromatography column which is capable of trapping or retarding and selectively releasing different fractions of the fluidic sample.

In the context of this document, the term “movement mechanism” may particularly denote a (e.g. mechanical) mechanism to move the lamp seat with respect to the housing of the detector. In an embodiment, the movement mechanism may be implemented by a movement device. In an embodiment, the moving mechanism may be configured to enable swiveling (pivoting) of the lamp seat with respect to the housing (move the lamp seat with a rotational/radial movement). For example, the lamp seat can be swiveled between a service position (such as may be oriented along a horizontal direction) and an operating orientation (such as may be oriented along a vertical direction). Such a movement mechanism may be implemented by a hinge mechanism. For example, the lamp seat may be hold in the service orientation and/or the operating orientation in a detachable manner, e.g. using a magnet. In a further embodiment, the movement mechanism may be configured to move the lamp seat in a linear direction with respect to the housing (moving the lamp seat with a linear movement), e.g. along a rail. The lamp seat may be moved inside of the housing or at least partially out of the housing. In an embodiment, the movement mechanism (in particular the swiveling) modifies/changes the angular orientation of the (main) axis of the lamp seat (in particular with respect to the housing). Thus, the lamp seat is not only moved into a parallel position (where the axis would not be changed), but tiled with respect to the housing, e.g. into a perpendicular position.

In the context of this document, the term “automatically results in an electric contact and/or a mechanical positioning” may in particular refer to the circumstance that moving the lamp seat from the service orientation to the operating orientation (establishing the operating orientation), e.g. by a rotational (swiveling) or a linear movement, results without further intervention and/or adjustment in the electric contact and/or the mechanical positioning. In an example, a swiveling into the service orientation may result in releasing the electric contact such that a service like exchanging a lamp can be done with no risk for the operator.

The term “electric contact” may hereby refer to an electric connection (in particular high-voltage) of the lamp in the lamp seat. For example, a terminal of the lamp may be connected to an electric contact of the lamp cap, but the electric contact of the lamp cap may only be electrically connected to an electric energy supply in the operating orientation. The term “mechanical positioning” may refer to a specific alignment of the lamp/lamp seat in the housing for (optimal) operation. For example, the lamp may be positioned with respect to an optical path without further adjustment.

According to an exemplary embodiment, the disclosure may be based on the idea that the lamp of a detector of an analytical device can be changed in an efficient and secure manner, when the detector comprises a movement mechanism to move the lamp seat (for receiving the lamp) with respect to the housing of the detector.

In a first embodiment, the movement mechanism is configured such that the lamp seat is swiveled with respect to the housing. For example, the lamp seat can be swiveled between a (horizontal) service orientation and a (vertical) operating orientation. In a second embodiment, the movement mechanism is configured such that the lamp seat is moved between the operating orientation and the service orientation, wherein the movement from the service orientation to the operating orientation results automatically in an electric contact and/or a mechanical positioning of the lamp. The positioning may comprise a specific alignment in/to an optical path.

The operating orientation, on the one hand, may enable that the lamp is only electrically connected in the operating orientation, thereby making exchange of the lamp secure for the operator. Further, the lamp may functionally align in the operating orientation so that no additional adjustment may be necessary. The service orientation, on the other hand, may enable a secure and easy exchange of the lamp, such as directly from an opening in the (frontside of the) housing.

According to the disclosure, the exchange of the lamp may be tool-free and/or free of adjustments. For instance, no screws need to be loosened or fastened (no risk for damaging the device) and no wrenches or screw-drivers are required (which can get lost) etc. The described lamp-exchange may further allow difficult-to-reach parts to be replaced or cleaned (lamp-housing window, optical filters, etc.). As a (normally) rod-shaped lamp can be removed lengthwise, the detector housing may be designed more compact. The described concept may be implemented into existing detectors and analytical devices in a straightforward manner.

### EXEMPLARY EMBODIMENTS

In an embodiment, the movement mechanism is configured to swivel the lamp seat between an operating orientation (e.g., vertical, electrically connected, mechanically aligned) and a service orientation (e.g., horizontal, electrically not connected, easy to push-in or pull-out). This may provide the advantage that the lamp seat can be switched between two important positions in an easy and user-friendly manner. The swiveling may be done manually or automatically. For example, a holding force such as a magnetic force may be overcome in order to move the lamp seat from one orientation to the other.

In an embodiment, the movement mechanism is configured to swivel the lamp seat around a vertical axis or around a horizontal axis with respect to the housing. In an embodiment, the lamp seat may be swiveled around a horizontal axis, so that the lamp is oriented in a vertical direction in one position and in a horizontal direction in another position. In this embodiment, the lamp seat may remain in the housing during lamp exchange. In a further embodiment, the lamp seat may be swiveled around a vertical axis, so that the lamp remains oriented in the vertical (or horizontal) direction during swiveling. In this embodiment, the lamp seat may be moved (at least partially) out of the housing for maintenance work such as lamp exchange.

In an embodiment the movement mechanism comprises a linear movement of the lamp seat, in particular along a guiding structure such as a rail. In comparison to the rotational movement of the swiveling, the movement mechanism may comprise a linear movement. For example, the lamp seat may be (at least partially) moved out of the housing for the lamp exchange. The lamp may hereby remain in the vertical direction. In order to implement such a linear movement, the lamp seat may be pulled out of the housing by a guiding structure, e.g. a rail. In other words, the lamp seat may be used like a drawer, when exchanging the lamp.

In an embodiment, in the operating orientation, the lamp seat is configured so that the lamp is electrically coupled for generating the electromagnetic radiation. This may provide the advantage that the lamp is (exclusively) electrically coupled, when being in the operating orientation, i.e. where the lamp is actually producing electromagnetic radiation.

In an embodiment, in the service orientation, the lamp seat is configured so that the lamp is electrically decoupled and can be removed from or inserted into the lamp seat. When not being in the electromagnetic radiation producing position, no electric contact is required, so that save handling is enabled.

In an embodiment, in the operating orientation, the lamp seat is configured so that the lamp is oriented along the vertical direction. Specific lamps, in particular in the context of (fluorescence) detection, may be configured to operate in a vertical orientation (in other words, the direction of main extension of the lamp is oriented (essentially) parallel to the vertical axis (z)). Thus, the orientation along the vertical direction may be the working position.

In an embodiment, in the service orientation, the lamp seat is configured so that the lamp is oriented along the horizontal direction. This architecture may enable an exchange of the lamp in a space-saving manner, by pushing in or pulling out the lamp in the viewing direction of the operator (in the depth of the instrument).

In an embodiment, the movement mechanism (in particular the rotation/swiveling) modifies/changes the angular orientation of the (main) axis of the lamp (seat) (in particular with respect to the housing). The axis of the lamp seat may be defined by the direction of main extension of the lamp seat. Such an axis may also be defined based on the lamp to be placed into the lamp seat. For example, such a lamp (compare FIG. 5) may have a direction of main extension (elongation from top to bottom in the Figure) that is normally oriented along the vertical direction, when in service (position). During the movement mechanism, the orientation of the axis may be changed, for example when the lamp seat (with or without lamp) is moved (swiveled) between a horizontal orientation (axis along the horizontal axis) and a vertical orientation (axis along the vertical axis) and/or between a parallel and a perpendicular position with respect to the housing. Thus, the lamp seat is not only moved into a parallel position (where the axis would not be changed) in this example, but tiled with respect to the housing, e.g. into a perpendicular position.

In a conventional example, one or more lamps can be located in a wheel that revolves around a central axis (“revolver configuration”). During revolving, the axial orientation of the lamp is maintained and only moved in parallel (around the central axis). Such an example may be excluded, when the angular orientation of the lamp (seat) with respect to the housing is modified (while in the conventional example, the angular orientation of the lamp remains the same and the axis is moved into a parallel position).

In an embodiment, the lamp comprises a direction of main extension, and wherein the axis of the lamp seat is (defined by being) parallel to the direction of main extension of the lamp.

In an embodiment, the movement mechanism is configured so that the lamp seat remains in the housing during the movement. Thereby, space may be saved, and the detector may be more compact.

In an embodiment, the lamp seat is at least partially moved out of the housing during the movement. This may provide the advantage that the (accommodation volume of the) lamp seat may be better reachable for an operator. For example, the lamp seat may be moved out of the housing by a linear movement (like a drawer) or by swiveling the lamp seat around a vertical axis (swing-out).

In an embodiment, the lamp seat is accessible to an operator in the service orientation, in particular exclusively in the service orientation. This may provide the advantage that the lamp exchange is (only) possible in a save service position without electric connection. In the more dangerous operating orientation, access to the lamp may be mechanically restricted to the operator.

In an embodiment, the lamp seat is accessible through an opening in the housing, in particular at a front side of the housing (see e.g. FIG. 2A). This may provide the advantage that the lamp seat may be directly accessible by an operator, in particular without opening the detector in a cumbersome manner (e.g. by removing many screws). The opening may be secured by a door, e.g. detachably arranged by a magnet. In an embodiment, opening the door may automatically disrupt the electric connection of the lamp.

In an embodiment, the detector further comprises: the lamp, insertable in the lamp seat. In an embodiment, the lamp is configured as a high-voltage lamp, in particular as a gas discharge lamp. In an embodiment, the lamp is configured to operate in a vertical position. In an embodiment, the lamp comprises a first terminal and/or a second terminal (for electric connection). In an embodiment, the lamp comprises a lamp body, and wherein the first terminal and the second terminal are arranged at axially opposing ends of the lamp body (see e.g. FIG. 5). In an embodiment, the lamp is rod-shaped. In an embodiment, the lamp comprises a main direction of extension (is elongated).

A high-voltage lamp may be a lamp requiring a high voltage for being operated, for example at least 1 kV (for instance for ignition). A gas-discharge lamp may be a light source that generates light by an electric discharge through an ionized gas, in particular a plasma. Such a high-voltage lamp, in particular gas discharge lamp, is highly appropriate for an HPLC-detector, since it is capable of providing a high intensity (wherein a high light intensity leads to a high sensitivity of a detector using a corresponding lamp), an appropriate wavelength range, and a sufficiently flat spectral profile. However, such high-voltage and/or gas discharge lamps may be dangerous during handling, since they may break easily and may even explode, thereby not only involving the risk of injury of a user but also exposing biohazardous materials, such as mercury. Thus, the self-aligning, electrical safety and overheating-protected configuration of lamp assemblies according to exemplary embodiments of the disclosure may be of utmost advantage. Since such dangerous gas discharge lamps are usually required to be handled with protection gloves and protection mask for safety reasons, the simple (in particular single-handed and/or toolless) handling according to exemplary embodiments of the disclosure is particularly advantageous.

In an embodiment, the lamp seat and the lamp are formed with matching shape so that inserting the lamp in the lamp seat leads to a self-alignment between the lamp seat and the lamp. Hence, an erroneous assembly by a user may be mechanically excluded by a form closure between lamp seat and lamp.

In an embodiment, the lamp seat comprises a first electric contact and the lamp seat is configured so that inserting the lamp into the lamp seat establishes an electric coupling between the lamp, in particular the first terminal, and the first electric contact.

In an embodiment, neither connecting the first electric contact nor the second electric contact causes a voltage or current to be supplied to the lamp (in the service orientation).

In an embodiment, the detector further comprises: a lamp cap to be mounted on the lamp seat, and thereby at least partially covering the lamp. In an embodiment, the lamp cap comprises a second electric contact. In an embodiment, the lamp cap is configured, so that inserting the lamp into the lamp seat and mounting the lamp cap on the lamp establishes an electric coupling between the lamp, in particular the second terminal, and the second electric contact.

In an embodiment, the lamp cap is attachable to the lamp seat and/or the lamp by a detachable mechanism, in particular at least one of a magnet, a screw, a clamp, a bayonet-mechanism/coupling. Thereby, the lamp cap may be mounted on the lamp seat in a straightforward and stable manner.

In an embodiment, the lamp seat and the lamp cap are configured to be connectable with each other by a bayonet mechanism, bayonet mount or bayonet connector. In particular, a bayonet mechanism, bayonet mount or bayonet connector may denote a fastening mechanism comprising a cylindrical male side with one or more radial pins, and a female receptor with one or more matching (in particular L-shaped) slots and optionally with one or more springs to keep the parts (i.e. lamp seat and lamp cap) locked together. The slots may be shaped like a capital letter L, optionally with a short upward segment at the end of the horizontal arm. The pin may slide into the vertical arm of the L, may rotate across the horizontal arm, and may then be pushed slightly upwards into the short upward segment by a spring, so that the connector is no longer free to rotate unless pushed down against the spring until the pin is out of the upward segment. Advantageously, such a bayonet mechanism may be operated by a user manually without tools, so that it may further facilitate the mounting process of the lamp-housing assembly. In particular, the provision of a bayonet mechanism may render screws dispensable, so that there will be no risk of sheared off metallic chipping (which can be problematic in view of electric reliability). Furthermore, a screwless lamp-housing assembly of an exemplary embodiment of the disclosure may be assembled and disassembled without tools. Thereby, the risk of damaging the instrument, e.g. by overtightening screws, may be mitigated.

While a bayonet mechanism is one embodiment, other fastening mechanisms for fastening lamp seat and lamp cap may be implemented in other embodiments. For example, another appropriate fastening mechanism may combine an undercut in one of the lamp seat and the lamp cap with a connection pin or other protrusion in the other one of the lamp seat and the lamp cap.

In an embodiment, the detector further comprises: an electric supply contact device, configured to supply electric energy to the lamp for operation, in particular via the second electric contact/electric supply contact of the lamp cap. In an embodiment, the movement mechanism is configured so that the electric contact with the electric supply contact device is exclusively established in the operating orientation. For example, the detector may comprise an electric supply contact device (e.g. a contact spring) to contact the lamp (via the second electric contact of the lamp cap), whereby the electric supply contact device may be arranged in a specific position, only forming an electric contact in the operating orientation. In an embodiment, the electric supply contact device comprises a contact spring, in particular a high-voltage contact spring.

In an embodiment, the lamp seat and the lamp are formed with matching shape, so that inserting the lamp in the lamp seat leads to a self-alignment between the lamp seat and the lamp. Thereby, the mechanical alignment may be implemented in a straightforward and reliable manner.

In an embodiment, the lamp seat comprises an electromagnetic radiation shielding structure, e.g. a cage. Thereby, accuracy during operation may be improved; for instance by shielding external radiation.

In an embodiment, the first electric contact and/or the second electric contact comprises annular contact springs. This may enable an especially reliable and easy to handle electric contact.

In an embodiment the detector (in particular movement mechanism) is configured to allow access to a further exchangeable part, in particular a filter element. For example, the opening in the housing may allow access to further difficult to reach parts such as optical filters (see e.g. FIGS. 4A to 4D). In an embodiment, the movement mechanism may make at least one of these further parts accessible.

In an embodiment, the movement mechanism is configured to fix the lamp seat in at least one position, in particular by a detachable mechanism, e.g. using a magnet, a clamp, etc.

In an embodiment, inserting/removing the lamp to/from the lamp seat comprises removing the lamp cap. Removing the lamp cap may provide access to an accommodation volume of the lamp seat for positioning the lamp.

In an embodiment, the detector is a fluorescence detector. In an embodiment, the detector comprises a flow cell through which the fluidic sample flows and which is illuminated by electromagnetic radiation generated by the lamp.

In an embodiment, the analytical device is configured as a sample separation device, in particular a fluidic chromatography device, more in particular a HPLC device.

In one embodiment, the sample separation device further comprises: a mixing point, where a sample is injected into the solvent, wherein the fluid compartment (the analytical device) is arranged upstream or downstream of the mixing point.

In one embodiment, the sample separation device further comprises: a solvent mixing point, where at least two solvent portions may be mixed, wherein the fluid compartment (the analytical device) is arranged upstream or downstream of the solvent mixing point.

In one embodiment, the sample separation device further comprises: a solvent drive, configured to drive the solvent as a mobile phase, wherein the fluid compartment (the analytical device) is arranged upstream or downstream of the solvent drive.

It becomes aware from the embodiments described directly above, that there is a high design flexibility regarding where the fluid compartment can be located in the analytical device/sample separation device. Depending on the present circumstances and the applied measurement method, different locations may be specifically favorable.

In one embodiment, the chromatography device comprises a mobile phase (solvent) drive and a separating device, wherein the mobile phase drive is configured for driving a mobile phase through the separating device, and the separating device is configured for chromatographically separating compounds of a sample fluid in the mobile phase.

In one embodiment, the analytical device and/or the sample separation device comprises a liquid chromatography system, wherein the sample fluid is a sample liquid, the mobile phase is comprised of one or more liquid solvents, and the separating device is a chromatographic column configured for separating compounds of the sample dissolved in the mobile phase.

In one embodiment, the chromatography device is a fluidic chromatography device, in particular a HPLC device.

Embodiments of the present disclosure might be embodied based on most conventionally available HPLC systems, such as the Agilent 1220, 1260 and 1290 Infinity LC Series (provided by the applicant Agilent Technologies).

The separating device may comprise a chromatographic column providing the stationary phase. The column might be a glass, metal, ceramic or a composite material tube (e.g. with a diameter from 50μm to 5 mm and a length of 1 cm to 1 m) or a microfluidic column (as disclosed, e.g., in EP 1577012 A1, the entire contents of which are incorporated by reference herein, or the Agilent 1200 Series HPLC-Chip/MS System provided by the applicant Agilent Technologies). The individual components are retained by the stationary phase differently and separate from each other while they are propagating at different speeds through the column with the eluent. At the end of the column, they elute at least partly separated from each other. During the entire chromatography process the eluent might be also collected in a series of fractions. The stationary phase or adsorbent in column chromatography usually is a solid material. The most common stationary phase for column chromatography is silica gel, followed by alumina.

The mobile phase (or eluent) can be either a pure solvent or a mixture of different solvents. It can also contain additives, i.e. be a solution of the additives in a solvent or a mixture of solvents. It can be chosen e.g. to adjust the retention of the compounds of interest and/or the amount of mobile phase to run the chromatography. The mobile phase can also be chosen so that the different compounds can be separated effectively. The mobile phase might comprise an organic solvent like e.g. methanol or acetonitrile, often diluted with water. For gradient operation, water and organic solvent are delivered in separate containers, from which the gradient pump delivers a programmed blend to the system. Other commonly used solvents may be isopropanol, tetrahydrofuran (THF), hexane, ethanol and/or any combination thereof or any combination of these with aforementioned solvents.

The sample fluid might comprise any type of process liquid, natural sample like juice, body fluids like plasma or it may be the result of a reaction like from a fermentation broth, bio reactor, digestion, or other type of sample preparation.

The fluid may be a liquid but may also be or comprise a gas and/or a supercritical fluid (as e.g. used in supercritical fluid chromatography—SFC—as disclosed e.g. in U.S. Pat. No. 4,982,597 A, the entire contents of which are incorporated by reference herein).

The pressure in the mobile phase might range from 2-200 MPa (20 to 2000 bar), in particular 10-150 MPa (100 to 1500 bar), and more particularly 50-130 MPa (500 to 1300 bar).

The HPLC system might further comprise a detector for detecting separated compounds of the sample fluid, a fractionating unit for outputting separated compounds of the sample fluid, or any combination thereof. Further details of HPLC system are disclosed with respect to the aforementioned Agilent HPLC series, provided by the applicant Agilent Technologies.

### BRIEF DESCRIPTION OF THE DRAWINGS

Other objects and many of the attendant advantages of embodiments of the present disclosure will be readily appreciated and become better understood by reference to the following more detailed description of embodiments in connection with the accompanying drawings. Features that are substantially or functionally equal or similar will be referred to by the same reference signs.

FIG. 1 illustrates an analytical device implemented as a liquid chromatography device, according to an exemplary embodiment.

FIG. 2A illustrates a front view of a detector, according to exemplary embodiments of the disclosure.

FIG. 2B illustrates a front view of a detector, according to exemplary embodiments of the disclosure.

FIG. 2C illustrates a front view of a detector, according to exemplary embodiments of the disclosure.

FIG. 3A illustrates a method of exchanging a lamp of a detector, according to an exemplary embodiment.

FIG. 3B illustrates a method of exchanging a lamp of a detector, according to an exemplary embodiment.

FIG. 3C illustrates a method of exchanging a lamp of a detector, according to an exemplary embodiment.

FIG. 3D illustrates a method of exchanging a lamp of a detector, according to an exemplary embodiment.

FIG. 3E illustrates a method of exchanging a lamp of a detector, according to an exemplary embodiment.

FIG. 3F illustrates a method of exchanging a lamp of a detector, according to an exemplary embodiment.

FIG. 4A illustrates exchanging further components of the detector, according to exemplary embodiments of the disclosure.

FIG. 4B illustrates exchanging further components of the detector, according to exemplary embodiments of the disclosure.

FIG. 4C illustrates exchanging further components of the detector, according to exemplary embodiments of the disclosure.

FIG. 4D illustrates exchanging further components of the detector, according to exemplary embodiments of the disclosure.

FIG. 5 illustrates a lamp for a detector, according to an exemplary embodiment of the disclosure.

### DETAILED DESCRIPTION

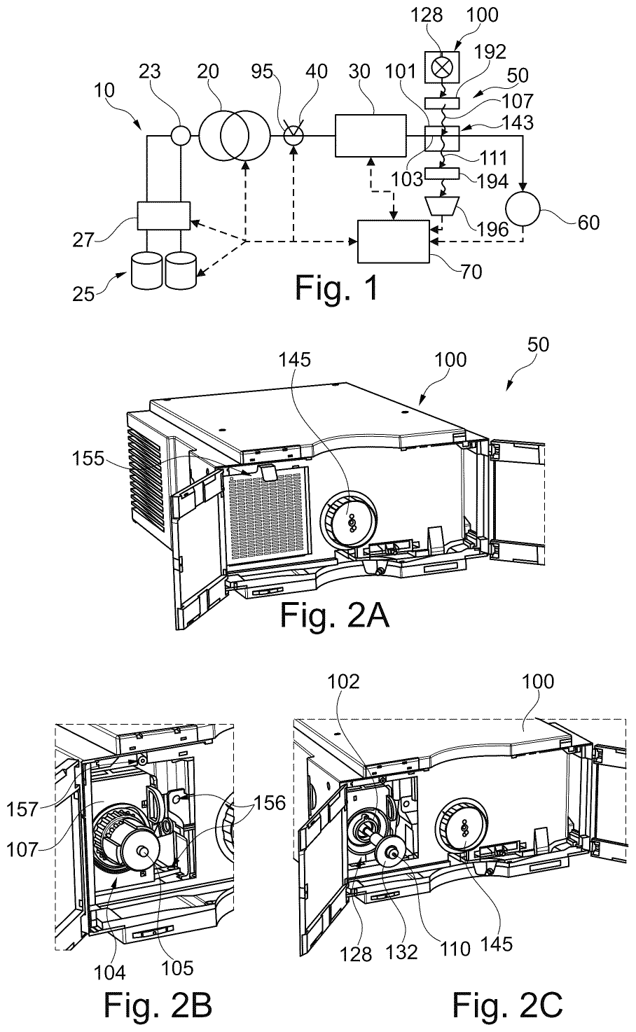

Referring now in greater detail to the drawings, FIG. 1 depicts a general schematic of an analytical device 10, implemented here as a high-performance liquid chromatography (HPLC) device. A solvent drive 20 (such as a pump, can be used as a pressurizing device) receives a solvent as the mobile phase from a solvent supply 25. The solvent drive 20 drives the mobile phase through a separating device 30 (such as a chromatographic column), which can be seen here as the analytical domain of the device. A sample injector 40 (also referred to as sampler, sampling space, sample introduction apparatus, sample dispatcher, etc.) is provided between the solvent drive 20 and the separating device 30 in order to subject or add (often referred to as sample introduction) portions of one or more sample fluids into the flow of a mobile phase at a mixing point, which may be via a fluid valve 95. The separating device 30 is adapted for separating compounds of the sample fluid, e.g. a liquid. A detector 50 is provided for detecting separated compounds of the sample fluid. A fractionating unit 60 can be provided for outputting separated compounds of sample fluid. In one embodiment, at least parts of the sample injector 40 and the fractionating unit 60 can be combined, e.g. in the sense that some common hardware is used as applied by both of the sample injector 40 and the fractionating unit 60.

The separating device 30 may comprise a stationary phase configured for separating compounds of the sample fluid. Alternatively, the separating device 30 may be based on a different separation principle (e.g. field flow fractionation).

While the mobile phase can comprise one solvent only, it may also be mixed of plurality of solvents (solvent supply 25). Such mixing might be a low pressure mixing and provided upstream of the solvent drive 20, so that the solvent drive 20 already receives and pumps the mixed solvents as the mobile phase. Alternatively, the solvent drive 20 might comprise plural individual pumping units, with plural of the pumping units each receiving and pumping a different solvent or mixture, so that the mixing of the mobile phase (as received by the separating device 30) occurs at high pressure and downstream of the mobile phase drive 20 (or as part thereof). The composition (mixture) of the mobile phase may be kept constant over time, the so-called isocratic mode, or varied over time, the so-called gradient mode.

A data processing device (control device) 70, which can be a conventional PC or workstation, might be coupled (as indicated by the dotted arrows) to one or more of the devices in the analytical device 10 in order to receive information and/or control operation.

A flow path can for example extend from the solvent drive 20 via the sample injection 40 and the separating device 30 (analytical domain) to the detector 50. Yet, the flow path can also extend through the detector 50 only. In the present example, the detector 50 is configured as a flow cell detector comprising a detection volume through which a fluidic sample may be passed for detection by electromagnetic (optical) radiation. In a specific example, the flow cell may comprise an at least partially transparent body with a hollow interior space through which a fluidic sample may flow, wherein the fluidic sample may be electromagnetically/optically detected while passing the hollow interior space (flow path). In a specific example, the detector 50 is configured as a fluorescence detector, measuring the fluorescence of the sample fluid passing through the flow path in the flow cell.

Now referring in detail to detector 50, an electromagnetic radiation source in the form of a lamp 128 in a housing 100 emits light as primary electromagnetic radiation, for instance a polychromatic beam with a broad range of wavelengths (for instance from 200 nm to 1100 nm). For example, lamp 128 may be a xenon arc lamp or a HgXe lamp. This broad range of primary electromagnetic radiation wavelengths may allow a user to select a narrow wavelength range from the broad wavelength range in accordance with a desired application. This wavelength selection may be made by an inlet monochromator 192, such as a Bragg grating. The inlet monochromator 192 may select a narrow bandwidth of for instance 15 nm to 20 nm for use as excitation electromagnetic radiation beam 107 in the shown fluorescence detector 50.

This wavelength-selected excitation electromagnetic radiation beam 107 may then propagate through an electromagnetic radiation inlet into a cuvette 101 of a flow cell 143. The fluidic sample, which has been separated by the sample separation unit 30, flows through a flow channel 103 extending along the cuvette 101. During flowing through the flow channel 103, the separated fluidic sample interacts with the excitation electromagnetic radiation beam 107, and can thereby be optically excited. For instance, certain amino acids, aromatic molecules, or fluorescence labels of a respective fraction of the separated fluidic sample may be excited by absorption of the excitation electromagnetic radiation.

After excitation, the fluidic sample may emit fluorescence radiation, which may propagate as emission electromagnetic radiation beam 111 to an electromagnetic radiation outlet. Although not shown in the schematic view of FIG. 1, the flow cell 143 may be configured so that a main propagation direction of the excitation electromagnetic radiation beam 107 is substantially perpendicular to a main propagation direction of the detected emission electromagnetic radiation beam 111. The emission electromagnetic radiation, being characteristic for a corresponding fraction of the fluidic sample, may then propagate to an emission monochromator 194, such as a Bragg grating. Descriptively speaking, the emission monochromator 194 may select a detection wavelength or a narrower detection wavelength range. In particular, emission monochromator 194 may filter out parasitic radiation, such as an optical underground as well as parasitic radiation created for instance by Raman and Rayleigh scattering. Emission electromagnetic radiation passing the emission monochromator 194 may then be detected by a detecting unit 196, such as a photodiode, a linear array of photocells, a two-dimensional camera (such as a CMOS camera or a CCD camera), a photomultiplier (tube, PMT). The detection data may be transmitted to control unit 70 for further processing.

FIG. 2A, FIG. 2B, and FIG. 2C respectively illustrate a front view of a detector 50, according to exemplary embodiments of the disclosure.

FIG. 2A: the detector 50 with the housing 100 is configured as a module (box) that can be stacked together with other modules (e.g. pump module, sampling module, separation module) as an HPLC stack. The doors at the front side of the detector 50 have been opened and one can see the central flow path coupling 145. Here, the flow path from a sample separation unit 30 can be coupled, so that the separated fluidic sample can be streamed (in a mobile phase) into the (flow cell of the) detector 50. Not shown in FIG. 2A is the flow cell arranged behind the flow path coupling 145.

Further, an opening 155 is formed in the frontside of the detector housing 100. In FIG. 2A, the opening 155 is closed by a grid-shaped door, and held in place by a magnet 157. There can be provided a door detection via light barrier, i.e. when the door is opened, lamp power is switched off.

FIG. 2B: the door before the opening 155 has been removed and the magnet 157 to hold the door is exposed. The lamp seat 102 has been moved by the movement mechanism (in particular by swiveling) into a horizontal position being the service orientation. The lamp 128 (not shown in FIG. 2B) is oriented, together with the lamp seat 102, along a horizontal axis. In this view, the top side of the lamp seat 102 can be seen and the lamp cap 104, that is mounted on top of the lamp 128 (and electrically contacting the lamp 128), when arranged in the lamp seat 102. The lamp cap 104 comprises an electric supply contact 105 that is connected, within the lamp seat 102, (and via an electric contact in the lamp cap 104) to an electric contact of the lamp 128. Since the electric supply contact 105 is not electrically connected in this service orientation to a source of electric power (see electric supply contact device 160 in other Figures), the lamp 128 is disconnected and an operator can handle the lamp 128 without danger. It can be further seen that the lamp seat 102 can be detachably fixed in the operating orientation and the present service orientation by magnets 156.

FIG. 2C: the lamp cap 104 (with the electric supply contact 105) has been removed (e.g. by a bayonet-type mechanism) and the inside of the lamp seat 102 (accommodation volume) can be seen. The lamp 128 with the upper/second terminal 110 and the disc-shaped section 132 is described in detail for FIG. 5. In the present view, the lamp 128 is in the process of being moved out of the lamp seat 102 to be exchanged.

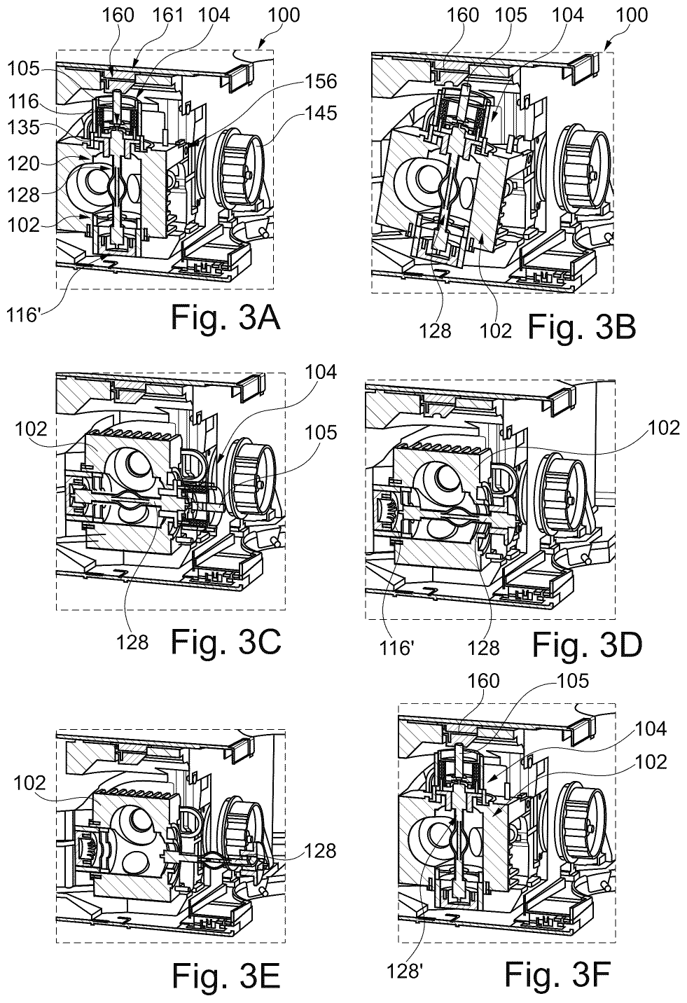

FIG. 3A, FIG. 3B, FIG. 3C, FIG. 3D, FIG. 3E, and FIG. 3F illustrate a method of exchanging a lamp 128 of a detector 50, according to an exemplary embodiment. The detector 50 described in FIGS. 2A to 2C is shown here in a side view cross-section.

FIG. 3A: shows the operating orientation of the lamp 128 and the lamp seat 102. The lamp 128 is rod-shaped and oriented in the lamp seat 102 along the vertical direction (z). A lower/first electric terminal 108 of the lamp 128 is electrically connected to a lower/first contact 116′ at the bottom of the lamp seat 102, and an upper/second electric terminal 110 of the lamp 128 is electrically connected (via an upper/second electric contact 116 of the lamp cap 104) to the electric supply contact 105 of the lamp cap 104. The lamp cap 104 is connected (here by a bayonet-type connection) to the lamp seat 102 and thereby covers the lamp 128. The electric supply contact 105 is further electrically connected to an electric supply contact device 160, in this example a high-voltage contact spring. In this operating orientation, the lamp 128 is automatically aligned in its working position, i.e. aligned to an optical path. No further adjustment is necessary; thus, the movement mechanism can electrically and mechanically contact the lamp 128 by moving/swiveling the lamp seat 102 into the operating orientation. It can be seen that the lamp seat 102 is detachably held in this position by magnets 156.

FIG. 3B: the movement mechanism is activated (automatically or manually) and the lamp seat 102 is swiveled with respect to the housing 100. When being moved out of the operating orientation, the electric contact to the electric supply contact device 160 is immediately separated, such that secure handling is possible. In other words, due to the swivelable interface, the high-voltage contact is separated by design during a lamp exchange. By applying a force to the lamp seat 102, the magnetic force of magnet 156 can be overcome.

FIG. 3C: the lamp seat 128 has been swiveled (by the movement mechanism) from the operating orientation to the service orientation. In this service orientation, the lamp 128 and the lamp seat 102 are both oriented along the horizontal direction (x, y). FIG. 3C can be seen as a side view of FIG. 2B: in both examples, the lamp cap 104 is exposed to an operator who accesses the lamp seat 102 through the opening 155 in the housing 100.

FIG. 3D: the lamp cap 104 has been removed and the lamp 128, in the accommodation volume of the lamp seat 102, is exposed and removed. FIG. 3D can be seen as a side view of FIG. 2C. In FIG. 3E, the lamp 128 is removed in the horizontal direction (pulled out) from the accommodation volume of the lamp seat 102 and a new lamp 128′ is pushed in.

FIG. 3F: after inserting a new lamp 128′ into the accommodation volume of the lamp seat 102, the lamp cap 104 has been mounted on the lamp seat 102 and the new lamp 128'. Then, the lamp seat 102 has been swiveled by the movement mechanism from the service orientation back to the operating orientation. Hereby, the movement from the service orientation to the operating orientation results automatically in an electric contact and a mechanical positioning of the lamp 128 in the detector 50. The electric contact is automatically established between the second terminal 110 of the lamp 128, the electric supply contact 105 of the lamp cap 104, and the electric supply contact device 160. The mechanical positioning is automatically established in the operating orientation, since the lamp 128 is aligned to the optical path in the orientation without further adjustments.

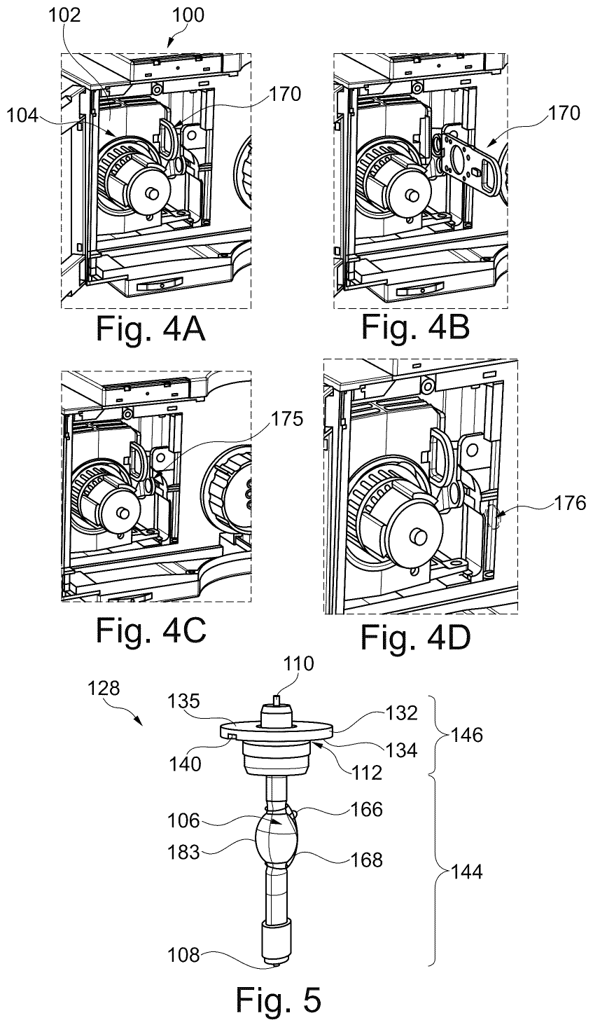

FIG. 4A, FIG. 4B, FIG. 4C, and FIG. 4D illustrate exchanging further components of the detector 50, according to exemplary embodiments of the disclosure. FIGS. 4A to 4D correspond to the view shown in FIG. 2B (see above). In this advantageous design, the opening 155 in the housing 100 can also be used to exchange further (difficult-to-reach) detector components in an efficient and reliable manner.

In FIG. 4A and FIG. 4B, a window slider of the detector 50 is easily exchanged. The housing window can be cleaned or exchanged from the frontside (tool-free). In FIG. 4C and FIG. 4D, a filter 176 from a filter wheel 175 is exchanged. Such optical filters 176 are used for calibration or performance purposes. Filters 176 are clipped into the filter wheel 175 with a spring plate and can be replaced in the service position.

FIG. 5 illustrates a lamp 128 according to an exemplary embodiment of the disclosure. In this example, a gas discharge-type lamp 128 is used that comprises a lamp body 106. Inside the lamp body 106, two spaced electrodes (not shown) are supplied with electric current to form a plasma in between which leads to the emission of light in the space between the electrodes. The electric current may be applied between a first electric terminal 108 and a second electric terminal 110 at axially opposing ends of the lamp body 106. For supplying electric current to the lamp 128, the lamp seat 102 comprises a bottom-sided set of first electric contacts (annular electrically conductive contact springs) 116′ configured for establishing an electric connection with the first electric terminal 108 when inserting the lamp 128 into the lamp seat 102. Correspondingly, a lamp cap 104 (which may be made of plastic material, for reliably ensuring electric isolation) comprises a top-sided second electric contact 116 (here a set of annular electrically conductive contact springs) configured for establishing an electric connection with the second electric terminal 110 when mounting the lamp cap 104 on the lamp seat 102 and on the inserted lamp 128.

Thus, the electric contacts (annular contact springs) 116′, 116 contribute both to the establishment of a mechanical connection and an electric connection between lamp 128 on the one hand and lamp seat 102 as well as lamp cap 104 on the other hand. Hence, the lamp seat 102, the lamp 128 and the lamp cap 104 are configured so that inserting the lamp 128 into the lamp seat 102 and mounting the lamp cap 104 on the lamp 128 and on the lamp seat 102 automatically establishes an electric coupling of the first electric terminal 108 and the second electric terminal 110 with counter electrodes in form of electric contacts 116, 116′ of the lamp seat 102 and of the lamp cap 104. Inside the lamp cap 104, a metallic member can be arranged for promoting heat removal by heat conduction.

In an example, lamp 128 may be a Hg-Xe-lamp with a spectral emission range from 185 nm to 2000 nm. A bulb material of lamp 128 may be fused silica. An electric power of lamp 150 may be 150 W. Lamp current may be about 7.5 A, whereas lamp voltage may be 20 V. A trigger voltage of the lamp 128 may be 15 kV.

When electric current is applied and lamp 128 emits light, a portion of the light propagates towards a flow cell (see reference sign 143, shown only in FIG. 1), in particular in a horizontal direction.

FIG. 5 further also illustrates a filler plug 166 of lamp body 106 for filling gas (such as xenon) into the lamp body 106. Moreover, FIG. 5 shows an electric field adjusting wire 168 for adjusting an electric field at the lamp body 106. As will be described in the following, lamp 128 will experience self-alignment both in a radial as well as in an axial direction when mounted in lamp seat 102 and when being covered by lamp cap 104. This self-alignment also ensures advantageously that electric field adjusting wire 168 will not be located in a light propagation path from lamp body 106 to the flow cell 143. This is advantageous, since it prevents weakening of the excitation light used in detector 50.

### REFERENCE SIGNS

10 Analytical device
20 Solvent drive
25 Solvent supply
27 Degasser
30 Separating device
40 Sample injector
50 Detector
60 Fractionating unit
70 Data processing device, control unit/device
100 Housing
101 Cuvette
102 Lamp seat
103 Flow channel
104 Lamp cap
105 Electric supply contact
106 Lamp body
107 Excitation electromagnetic radiation beam
108 First terminal
110 Second terminal
111 Emission electromagnetic radiation beam
116′ First electric contact
116 Second electric contact
128 Lamp
132 Disc-shaped section
134 Mounting surface
135 Mounting surface
140 Engagement structure
143 Flow cell
144 Lamp seat-sided position
145 Flow path coupling
146 Lamp cap-sided position
155 Opening
156 Lamp seat magnet
157 Door magnet
160 Electric supply contact device
161 Lid
166 Filter plug
168 Electric filed adjusting wire
170 Window slider
175 Filter wheel
176 Filter
183 Light emitting portion
192 Inlet monochromator
194 Emission monochromator
196 Detecting unit

1. A detector for an analytical device, the detector comprising:
a housing;
a lamp seat arranged in the housing and configured to receive a lamp for generating an electromagnetic radiation; and
a movement mechanism configured to swivel the lamp seat with respect to the housing.

2. The detector according to claim 1, wherein the movement mechanism is configured to swivel the lamp seat between an operating orientation and a service orientation.

3. The detector according to claim 1, wherein the movement mechanism is configured to swivel the lamp seat around a vertical axis or around a horizontal axis with respect to the housing.

4. The detector according to claim 2, wherein the movement mechanism is configured so that the movement from the service orientation to the operating orientation results automatically in an electric contact and/or a mechanical positioning of the lamp.

5. A detector for an analytical device, the detector comprising:
a housing;
a lamp seat arranged in the housing and configured to receive a lamp for generating an electromagnetic signal; and
a movement mechanism configured to move the lamp seat between an operating orientation and a service orientation, so that the movement from the service orientation to the operating orientation results automatically in an electric contact and/or a mechanical positioning of the lamp.

6. The detector according to claim 5, wherein the movement mechanism comprises a linear movement of the lamp seat along a guiding structure.

7. The detector according to claim 2, comprising at least one of the following features:
wherein, in the operating orientation, the lamp seat is configured so that the lamp is electrically coupled for generating the electromagnetic radiation;
wherein, in the service orientation, the lamp seat is configured so that the lamp is electrically decoupled and can be removed from or inserted into the lamp seat;
wherein, in the operating orientation, the lamp seat is configured so that the lamp is oriented along the vertical direction;
wherein, in the service orientation, the lamp seat is configured so that the lamp is oriented along the horizontal direction.

8. The detector according to claim 1, wherein the movement mechanism is configured such that swiveling thereby modifies an angular orientation of the axis of the lamp seat with respect to the housing.

9. The detector according to claim 1, wherein the movement mechanism is configured so that the lamp seat remains in the housing during the movement, or the lamp seat is at least partially moved out of the housing during the movement.

10. The detector according to claim 1, comprising at least one of the following features:
wherein the lamp seat is accessible to an operator in the service orientation;
wherein the lamp seat is accessible to an operator exclusively in the service orientation; and/or
wherein the lamp seat is accessible through an opening in the housing;
wherein the lamp seat is accessible through an opening at a front side of the housing.

11. The detector according to claim 1, comprising the lamp insertable in the lamp seat and comprising at least one of the following features:
wherein the lamp is configured as a high-voltage lamp;
wherein the lamp is configured as a gas discharge lamp;
wherein the lamp is configured to operate in a vertical position;
wherein the lamp comprises a first terminal and/or a second terminal;
wherein the lamp comprises a first terminal and/or a second terminal, and a lamp body, and the first terminal and/or the second terminal are arranged at axially opposing ends of the lamp body;
wherein the lamp is rod-shaped;
wherein the lamp comprises a direction of main extension, and wherein the axis of the lamp seat is oriented in parallel to the direction of main extension.

12. The detector according to claim 1, wherein:
the lamp seat comprises a first electric contact; and
the lamp seat is configured so that inserting the lamp into the lamp seat establishes an electric coupling between the lamp and the first electric contact.

13. The detector according to claim 1, comprising a lamp cap to be mounted on the lamp seat and thereby at least partially covering the lamp, wherein:
the lamp cap comprises a second electric contact; and
the lamp cap is configured so that inserting the lamp into the lamp seat and mounting the lamp cap on the lamp establishes an electric coupling between the lamp and the second electric contact.

14. The detector according to claim 1, comprising at least one of the following features:
wherein the lamp cap is attachable to the lamp seat and/or the lamp by a detachable mechanism;
wherein the lamp cap is attachable to the lamp seat and/or the lamp by a bayonet-mechanism.

15. The detector according to claim 1, comprising an electric supply contact device configured to supply electric energy to the lamp for operation, the movement mechanism is configured so that electric contact with the electric supply contact device is exclusively established in the operating orientation.

16. The detector according to claim 1, comprising at least one of the following features:
wherein the lamp seat and the lamp are formed with matching shape, so that inserting the lamp in the lamp seat leads to a self-alignment between the lamp seat and the lamp;
the lamp seat comprises an electromagnetic radiation shielding structure;
wherein the first electric contact and/or the second electric contact comprises annular contact springs;
wherein the supply electric contact comprises a contact spring;
wherein the movement mechanism is configured to allow access to an exchangeable part;
wherein the movement mechanism is configured to allow access to a filter element;
wherein the movement mechanism is configured to fix the lamp seat in at least one position;
wherein the movement mechanism is configured to fix the lamp seat in at least one position by a detachable mechanism;
wherein inserting/removing the lamp to/from the lamp seat comprises removing the lamp cap.

17. The detector according to claim 1, comprising at least one of the following features:
wherein the detector is a fluorescence detector;
wherein the detector comprises a flow cell through which the fluidic sample flows and which is illuminated by electromagnetic radiation generated by the lamp.

18. An analytical device for analyzing a fluidic sample, wherein the analytical device comprises:
the detector according to claim 1; and
a sample separation unit configured to separate the fluidic sample upstream of the detector.

19. The analytical device according to claim 18, configured as a sample separation device comprising at least one of the following features:
the sample separation device is configured as a chromatography sample separation apparatus;
the sample separation unit is configured as a chromatographic separation column;
an injector configured to inject the fluidic sample into the mobile phase;
a fractionating unit configured to collect the separated fluidic sample;
a degassing apparatus configured to degas at least part of the mobile phase.

20. A method for changing a lamp of a detector of an analytical device, the method comprising:
moving a lamp seat with respect to a housing of the detector between an operating orientation and a service orientation;
inserting the lamp in the lamp seat and/or removing the lamp from the lamp seat in the service orientation; and
electrically connecting the lamp in the operating orientation,
wherein moving comprises at least one of the following features:
wherein moving comprises a swiveling; and/or
wherein moving between the service orientation and the operating orientation results automatically in an electric contact and/or a mechanical positioning of the lamp.
